(19) United States
(12) Patent Application Publication
(10) Pub. No.: US 2026/0064897 A1
(43) Pub. Date: Mar. 5, 2026

(54) INTERACTIVE CONSTRAINT MODULATION IN DESIGN SPACE EXPLORATION

(71) Applicant: Siemens Industry Software Inc., Plano, TX (US)

(72) Inventor: Dhebar Deepakkumar Yashesh, East Lansing, MI (US)

(73) Assignee: Siemens Industry Software Inc., Plano, TX (US)

(21) Appl. No.: 18/825,544

(22) Filed: Sep. 5, 2024

(51) Int. Cl. G06F 30/12; G06F 111/04

(52) U.S. Cl. CPC G06F 30/12; G06F 2111/04

(57) ABSTRACT

Methods for automated design search and corresponding systems and computer-readable mediums. A method (600) includes receiving (602) an automated design search (ADS) specification (154). The method includes receiving (604) design search data (166). The method includes receiving (606) a plurality of constraints (156), each constraint (156) having an associated constraint threshold (156) and computing and displaying (608) an initial output (400) of potential ADS solutions (158) according to the ADS specification (154), the design search data (166), and the constraints (156). The method includes receiving (610) a constraint relaxation input (162) from a user and, in response to receiving (610) the constraint relaxation input (162), computing and displaying (612) an updated output (500) of potential ADS solutions (158), according to the ADS specification (154), the constraints (156), the design search data (166), and the constraint relaxation input (162). The method can include dynamically and repeatedly updating (612) the updated output (500) when the constraint relaxation input (162) continues to be received (610).

### TECHNICAL FIELD

The present disclosure is directed, in general, to systems and methods for computer-aided design (CAD), computer-aided engineering (CAE), and other processes, and can in particular be applied to techniques for modulating constraints in automated design search systems. While certain examples in the description below are described in terms of a CAD and CAE use case, disclosed embodiments can be used for any design space exploration task, including supply chain, operational research, etc.

### BACKGROUND OF THE DISCLOSURE

Automated Design Search (ADS) refers to the use of computational algorithms and techniques to explore a vast space of design possibilities to identify optimal or near-optimal design solutions. This process leverages various optimization methods, including machine learning, evolutionary algorithms, and other computational strategies, to automate and accelerate the design process in various engineering and architectural fields. ADS uses optimization algorithms to systematically explore the design space and evaluate different design options. Algorithms such as genetic algorithms, particle swarm optimization, and simulated annealing are commonly employed. ADS often involves simulating the performance of different designs to assess their effectiveness. This can include computational fluid dynamics (CFD), structural analysis, and other domain-specific simulations.

ADS systems explore different regions of design space and generate a wide range of designs by varying design parameters. This helps in understanding the impact of different variables on the performance of the design. ADS systems can use objective functions as mathematical representations of the goals of the design process, such as minimizing weight, maximizing strength, or optimizing cost. The optimization algorithms aim to find designs that best meet these objectives.

ADS systems can use design constraints, described in more detail below. Design constraints divides the search space into feasible and infeasible regions. Feasible regions in the design space are those where the conditions imposed by the set of design constraints is satisfied. A solution generated by ADS is called a “feasible solution” if it lies in the feasible region. A solution is flagged as an “infeasible solution” if it lies outside the feasible region, i.e. it violates the at least of the design constraint. The boundary separating “feasible” and “infeasible” region is called a “constraint boundary”. By changing the constraint definition, this boundary can be modulated. Currently, any change to the constraints requires a tedious manual process and requires reconfiguration to reflect any changes to the corresponding solution. Improved systems are desirable.

### SUMMARY OF THE DISCLOSURE

Various disclosed embodiments include methods for automated design search and corresponding systems and computer-readable mediums. A method includes receiving an automated design search (ADS) specification. The method includes receiving design search data. The method includes receiving a plurality of constraints, each constraint having an associated constraint threshold and computing and displaying an initial output of potential ADS solutions according to the ADS specification and the constraints. The method includes receiving a constraint relaxation input from a user and, in response to receiving the constraint relaxation input, the system computing and displaying an updated output of potential ADS solutions, according to the ADS specification, the constraints, and the constraint relaxation input.

In some embodiments, the method includes dynamically and repeatedly updating the updated output when the constraint relaxation input continues to be received. In various embodiments, the ADS specification includes one or more of design variables, objective functions, constraints, performance metrics and evaluation criteria, algorithm parameters, or environmental and operational conditions.

In various embodiments, the initial output includes an objective plot, a performance plot, and/or a constraint analyzer chart. In various embodiments, the initial output includes an objective plot that displays Pareto points and infeasible points. In various embodiments, the initial output includes a constraint analyzer chart that indicates whether each constraint is satisfied across an entire point set, such as an entire optimal or potential optimal point set, or is violated.

In various embodiments, the constraint relaxation input can be used to modify the constraint thresholds of the constraints. In various embodiments, the constraint relaxation input is received via a user interaction with a slider graphical user interface element on the initial output. In various embodiments, the constraint relaxation input ranges from zero to a predetermined maximum. In various embodiments, the constraint relaxation input ranges from a predetermined minimum value to a predetermined maximum value.

In various embodiments, the updated output includes original Pareto points that are illustrated in the initial output and includes potential Pareto points. In various embodiments, the updated output includes an updated constraint analyzer chart that indicates whether the plurality of constraints are satisfied under the original definition of the optimization problem when the global constraint relaxation input is used to implicitly modify the constraint thresholds of one or more constraints. In various embodiments, the constraint relaxation threshold can be adjusted for each constraint individually using dedicated sliders corresponding to each constraint.

Various embodiments include a computer system comprising a processor and an accessible memory, the computer system particularly configured to perform processes as disclosed herein. Various embodiments include a non-transitory computer-readable medium encoded with executable instructions that, when executed, cause one or more computer systems to perform a processes as disclosed herein.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a computer system in which an embodiment can be implemented;

FIG. 2 illustrates a two-objective constraint optimization problem in accordance with disclosed embodiments;

FIGS. 3A and 3B illustrate the results of a visualization process;

FIG. 4 illustrates an example of a user interface for a system in accordance with disclosed embodiments;

FIG. 5 illustrates an example of an updated user interface for a system in accordance with disclosed embodiments; and

FIG. 6 illustrates a flowchart of a process in accordance with disclosed embodiments.

### DETAILED DESCRIPTION

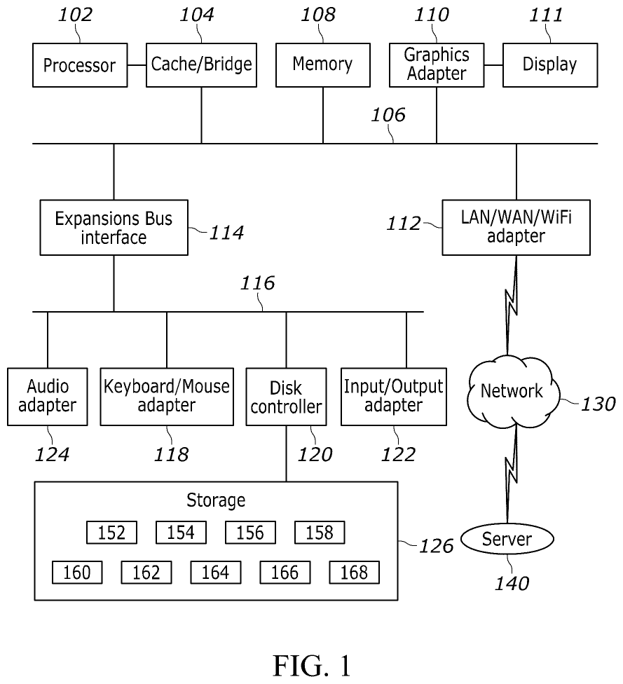

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In the context of automated design search (ADS), constraints are specific conditions or limitations that a design must satisfy to be considered valid. These constraints ensure that the resulting designs are feasible, safe, functional, and meet specific performance criteria. Constraints play a crucial role in guiding the optimization process by limiting the design space to realistic and acceptable solutions.

Geometric constraints can include shape and size restrictions on dimensions, angles, and overall shape of the design. For example, the length, width, and height of a component might need to fit within certain bounds. Other geometric constraints can include requirements for symmetry in the design for aesthetic or functional reasons.

Material constraints can include material property constraints such as limits on the types of materials that can be used based on properties such as strength, weight, thermal conductivity, and elasticity. Structural constraints can include such considerations as load-bearing capacity, stiffness and stability. Performance constraints can include efficiency considerations such as limits on energy consumption, speed, or other performance metrics that the design must meet, or functionality considerations such as requirements that the design performs certain functions or achieves specific outputs.

Manufacturing constraints can include considerations such as restrictions based on the manufacturing processes available, such as additive manufacturing, casting, or machining, and precision tolerance requirements for the dimensions and assembly of the design components.

In ADS systems, constraints are expressed mathematically and divide the design space into feasible and infeasible regions. An original set of optimal solutions corresponding to the original definition of the design space exploration problem reside solely in the feasible region. However, modulation and modification of constraint boundaries, which act as a divider between feasible and infeasible regions, can lead to a new set of optimal solutions. As described above, extraction of this new set of optimal solutions, referred to herein as a set of potential solutions, is a tedious, manual process that must be re-performed if a constraint is modified.

Disclosed embodiments provide systems and methods for automated design search, and for processing a design database, that allows flexible application of constraints in order to filter potential solutions without eliminating valuable solutions. The techniques disclosed herein provide a distinct technical advantage in providing automated design search systems and methods, analyzing the output of such design search systems, and related CAD/CAE and other systems, that conduct more efficient, flexible, and productive design searches and facility that extraction and potential discovery of valuable designs.

FIG. 1 illustrates a block diagram of a computer system in which an embodiment can be implemented, for example as a computer system particularly configured by software or otherwise to perform the processes as described herein, and in particular as each one of a plurality of interconnected and communicating systems as described herein. The computer system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 126 can store any data that may be necessary or useful for performing processes as described herein, including (but not limited to) executable code 152, ADS specification 154, constraints (and associated constraint thresholds) 156, ADS solutions 158, ADS applications 160 (including any supporting executable, display, PLC, or interface code), constraint relaxation input 162, graphical user interface/output data 164, design search data 166, and other data 168.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A computer system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of computer system 100), which can be any public or private computer system network or combination of networks, as known to those of skill in the art, including the Internet. Computer system 100 can communicate over network 130 with server system 140, which is also not part of computer system 100, but can be implemented, for example, as a separate computer system 100.

In an automated design search, design engineers supply information such as the objective or set of objectives to be minimized/maximized and some design constraints. The design constraints determine if the design is feasible by determining whether it satisfies the design constraints. In an automated design search conducted by conventional design space exploration software, such as the HEEDS design space exploration and optimization software by Siemens, multiple designs may be identified. The intent of this automated design search is to search for the feasible design or set of feasible designs which optimizes the objectives supplied by the design engineer, while satisfying the conditions imposed by set of constraints. Mathematically, without the loss of generality, a generic optimization problem can be represented using the following formulation:

$$\begin{matrix}min {f}_{1} ( x ) , {f}_{2} ( x ) , … , {f}_{M} ( x ) \\ s . t . {g}_{1} ( x ) - {τ}_{1} \leq 0 \\ {g}_{2} ( x ) - {τ}_{2} \leq 0 \\ ⋯ \\ {g}_{C} ( x ) - {τ}_{c} \leq 0\end{matrix}$$

where “fᵢ”s represent objectives, “gᵢ”s represent constraints, “τᵢ”s represent constraint thresholds, and x is a design variable vector (or simply, a “design”).

Without the loss of generality, assume that all objectives (i.e., fᵢ) are minimized and all constraints are a “less than or equal to” type. For a design to be feasible, design x must satisfy all constraints, i.e., gᵢ (x)−τᵢ≤0 ∀i. In the above formulation, constraint relaxation/tightness can be adjusted by changing the value of constraint threshold τᵢ. Here, the constraint relaxation can be achieved by increasing the value of τᵢ, or it can be made tighter by reducing the value of τᵢ.

For a single objective optimization problem, (i.e., M=1) in the above equation, there is a single best achievable optimal objective value, but for multi/many objective optimization problems (i.e., M≥2), there are multiple sets of trade-off optimal solutions, which are often referred to as “Pareto solutions.”

In the context of automated design search, a Pareto set (or Pareto front) refers to a collection of design solutions that are considered optimal in a multi-objective optimization problem. These solutions are optimal in the sense that no other solutions in the design space can improve one objective without worsening at least one other objective. ADS often involves optimizing multiple, sometimes conflicting objectives. For instance, in engineering design, one might need to minimize weight while maximizing strength. The Pareto set comprises solutions that offer the best trade-offs among these objectives.

A solution is Pareto optimal (or non-dominated) if there is no other solution that improves one objective without degrading another. In other words, within the Pareto set, one cannot find a single solution that is unequivocally better than another across all objectives. The Pareto front is often visualized in a graph where each axis represents a different objective. The set of points that form the front represents the Pareto-optimal solutions. This visualization helps in understanding the trade-offs between different objectives.

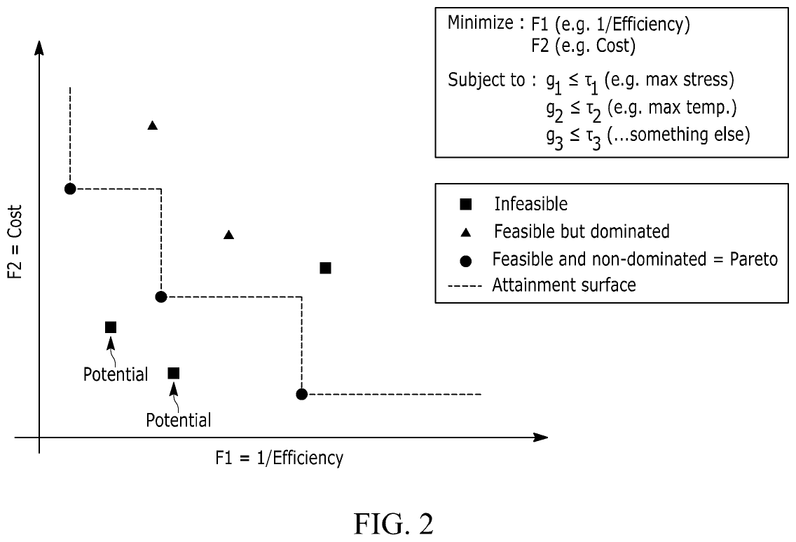

FIG. 2 illustrates a two-objective constraint optimization problem in accordance with disclosed embodiments. Since the objectives are conflicting in nature, users are interested in knowing best possible trade-off solutions constituting a Pareto set (designated as “Feasible and Non-Dominated”).

In this figure, the final set of optimal solutions are designated as “Feasible and Non-Dominated”. These solutions are non-dominated set of solutions since there are no feasible solutions beneath the attainment surface connecting them (indicated by the dotted line). The solutions designated as “Infeasible” are infeasible solutions, meaning they violate one or more design constraints. Often, in real world practice, some of the constraint thresholds (τᵢ) which are supplied by design teams/engineers are malleable, meaning they are allowed to be relaxed. Furthermore, in some cases, design engineers are curious to know what happens if they relax some of these constraints. In the example of FIG. 2, it is possible that for some value of constraint relaxation (achieved by increasing the value of τᵢ), some of the “potential solutions” (indicated by arrow in FIG. 2) might qualify the “relaxed constraint criteria,” thereby promoting them to be included in the Pareto set.

As can be seen in FIG. 2, these potential solutions are better than some of the Pareto solutions of the original problem (Feasible and Non-Dominated) and sometimes design engineers will tend to prefer these potential solutions provided that the constraint relaxation is acceptable. These potential solutions provide significant business advantages if the improvement observed in the objectives is substantial than the compromise over some malleable constraints.

Furthermore, the potential solutions can additionally serve as “target solutions” in optimization processes to attempt to get near or beyond the target objective values while ensuring feasibility as imposed by original constraint thresholds.

Disclosed embodiments provide an efficient approach to filtering out these potential solutions based on constraint relaxations.

One approach for filtering involves “coloring” the solutions based on individual constraint values. This requires the creation of J different scatter points for J different constraints. Other approaches may filter solutions by supplying the “filter-range” for each constraint individually. However, this approach requires a significant amount of trial and error to setup the filter-range of each constraint and becomes overwhelming when there are many potential solutions or more than two constraints, which is usually the case in real world design-space exploration problems.

Interactive visualization may require complex steps such as generating a two-dimensional (2D) relational plot (for two-objective problems) with one objective on the X-axis and a second objective on the Y-axis. The system can then highlight a non-dominated set of points (i.e., Pareto set) in this plot. The system can then create a parallel coordinate plot (PCP) showing maximum and minimum values realized by each constraint in the design space exploration. The system can then interactively select the range for one of the constraints in the PCP, and all solutions satisfying the range are highlighted in the 2D relational plot. The user must then manually inspect and identify the new set of non-dominated Pareto points from the highlighted set.

As can be seen, the last step of manually inspecting the non-dominated set from the set of highlighted points is cumbersome and sometimes impossible.

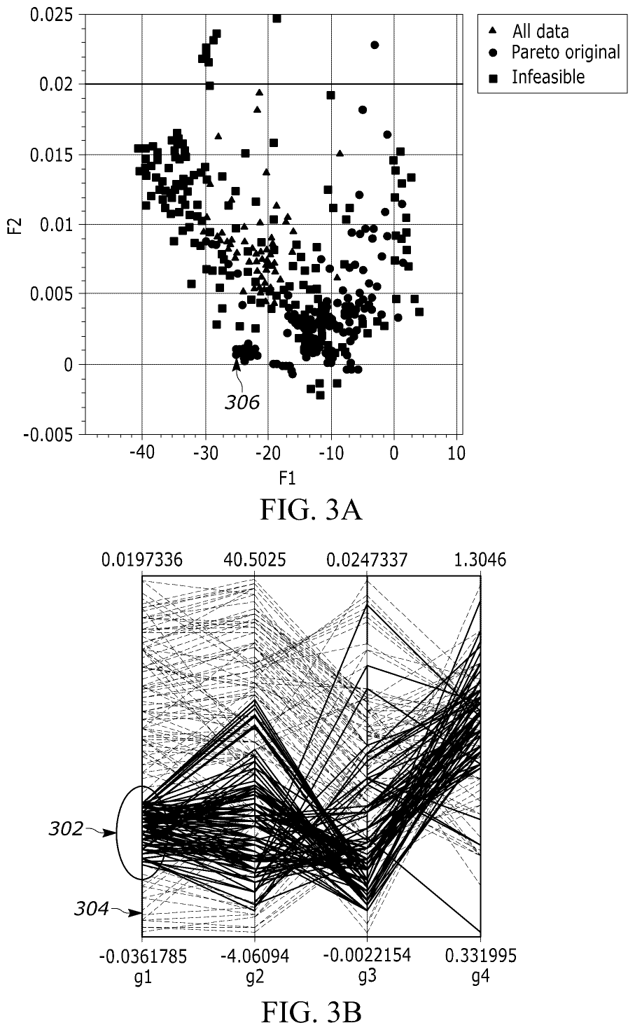

FIGS. 3A and 3B illustrate the results of such a visualization process, where FIG. 3A illustrates a relational plot, indicating the infeasible and Pareto optimal points; and FIG. 3B illustrates the corresponding constraint graph, with the constraint range of constraint g1 indicated at 302. Each line in FIG. 3B that passes through the vertical lines of constraints corresponds to one of the design points in FIG. 3A. The segment of vertical line indicated with 304 in FIG. 3B indicates the range in which that particular constraint is violated. The oval 302 highlights subset of this infeasible range for g1. All solutions corresponding to this selection are highlighted with “solid black” lines in FIG. 3B and transparent squares in FIG. 3A (note, all these designs are infeasible since they violate constraint g1). Upon visual inspection, the lower left region of this selection which dominates some of the original Pareto Points (marked with squares 306 in FIG. 3A) are the “potential Pareto points” as described above. As is evident from this example, the overall process demands multiple manual steps to set up the plot and even after that, it is a daunting task to efficiently determine potential Pareto points.

Disclosed embodiments, by contrast, enable the system to provide an easy, convenient, and intuitive process and interface to filter the potential Pareto solutions using interactive constraint modulation.

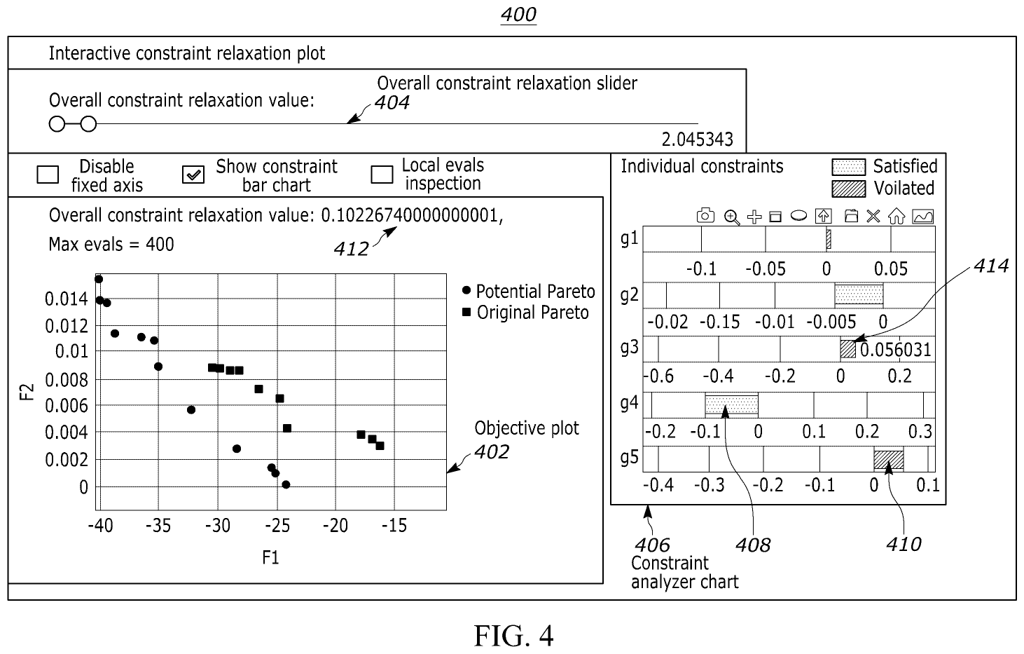

FIG. 4 illustrates an example of a user interface 400 for a system in accordance with disclosed embodiments, that allows the system to interact with a user to dynamically adjust constraint “relaxation.” In this example, user interface 400 includes an objective plot 402 of the potential Pareto points and original Pareto points for objectives F1 and F2.

User interface 400 also includes an overall constraint relaxation “slider” 404 feature that allows the user to easily enter (and the system to receive) a dynamic adjustment of an overall constraint relaxation value, from zero to a maximum. Constraint analyzer chart 406 displays constraint ranges for each individual constraint. The system dynamically “connects” objective plot 402, slider 404, and constraint analyzer chart 406.

As the slider 404 is adjusted, the system automatically updates the objective plot 402 and the constraint analyzer chart 406 to reflect the changed constraint relaxation values. Depending on value of slider 404, the constraint analyzer chart 406 can indicate, using colors or otherwise, whether a given constraint (with reference to its original definition) is satisfied across the entire point set of Potential Pareto points (e.g., at 408) or is violated (e.g. at 410).

Slider 404 is used to conveniently modulate the net constraint relaxation value. In the example of FIG. 4, it ranges from 0 to a certain maximum value (in this case, 2.045348) but various embodiments can include a slider ranges from a maximum possible negative value to a maximum positive value (e.g., −1 to 1). In this example, a positive value for slider 404 indicates a level of constraint “relaxation”, while a negative value reflects a level of constraint “tightness.” In other implementations, other conventions can be used, e.g., negative values indicate constraint relaxation while positive values indicated constraint tightness. In the example of FIG. 4, the constraint relaxation slider has been set to the value of about 0.1 (as indicated at 412).

In this example, objective plot 402 is a two-objective plot, but various embodiments can display and process a larger number of objectives and or can be degenerated to a single objective/performance plot. While various embodiments can have any number of sets of points, this example illustrates original Pareto points and potential Pareto points.

Original Pareto points are the set Pareto-optimal points achieved as a result of conducting design space exploration on the original design optimization problem. They are all feasible and satisfy all the conditions imposed by constraints. Potential Pareto points are the set of points in the database of design space exploration search which are infeasible and violate at least one of the constraints. Further, the potential Pareto points are Pareto-optimal points for the modified design optimization problem with relaxed constraint boundaries as determined by slider 404 and length of red/violated bars (such as 414) in constraint analyzer chart 406. If the overall constraint relaxation value is set to zero (or other determined “neutral” value), these set of potential Pareto points will coincide with the original Pareto points.

The constraint analyzer chart 406 is a dynamic chart which can capture the statistics of all design constraints and their feasibility/violation values as observed in the data. To produce this chart 406, in various embodiments, the system evaluates the potential Pareto points and determines and displays the “worst” constraint value observed across the potential Pareto points. If the worst value for a given constraint gᵢ is negative, it indicates that the gᵢ constraint was satisfied in all potential Pareto solutions. Additionally, the negative value also indicates the extent to which this constraint was satisfied. Since the constraint is satisfied, the extent or amount of its constraint satisfaction is also displayed, such as in a different color or using some other indication.

Conversely, if the worst value for a given constraint gᵢ assumed by points in the potential Pareto set is positive, the system can determine that the gᵢ was not satisfied by at least one point in the potential Pareto set. The extent of the infeasibility of gᵢ can be reflected, for example, by a positive number and can be displayed using a different color or other indication of its infeasibility, such as a red band.

In the example plot illustrated in FIG. 4, constraints g2 and g4 are satisfied by all potential Pareto solutions, which is displayed as a band such as at 408, for example in a specific pattern or color (such as green). While various embodiments can use specific colors such as green for “satisfied” and red for “violated,” the nature of the line drawing of FIG. 4 uses patterning for the same indication.

By contrast, constraints g1, g3, and g5 are violated by some of the points in the potential Pareto set, for example as indicated at 410. The degree of violation for these constraints varies.

The length of the indicated band as displayed by the system, such as a green/satisfied band for satisfied constraints and a red/violated band for violated constraints, allows a user to intuitively and quantitatively gauge the extent to which the given constraint has been satisfied or violated and draw useful insights. For instance, focusing on the violated set of constraints (i.e., constraints g1, g3, and g5), it is immediately apparent that constraint g1 is violated the least while constraint g5 is violated the most. In some embodiments, the system can respond to an input such as a mouse “hover” by displaying the specific degree of violation, such as shown at 414 for constraint g3 (which is violated by about 0.0569).

Constraint analyzer chart 406 as displayed by the system provides very valuable insights to design engineers and decision makers. For the example in FIG. 4, constraint analyzer chart 406 immediately informs design engineers that when using solutions from the potential Pareto set, they need not worry about constraints g2 and g4 since they are comfortably satisfied. Additionally, the system indicates using constraint analyzer chart 406 direct information about the amount of constraint relaxation that is needed for constraints g1, g3, and g5 when the engineers are using the potential Pareto solutions, and can update this information dynamically when the slider 404 is manipulated.

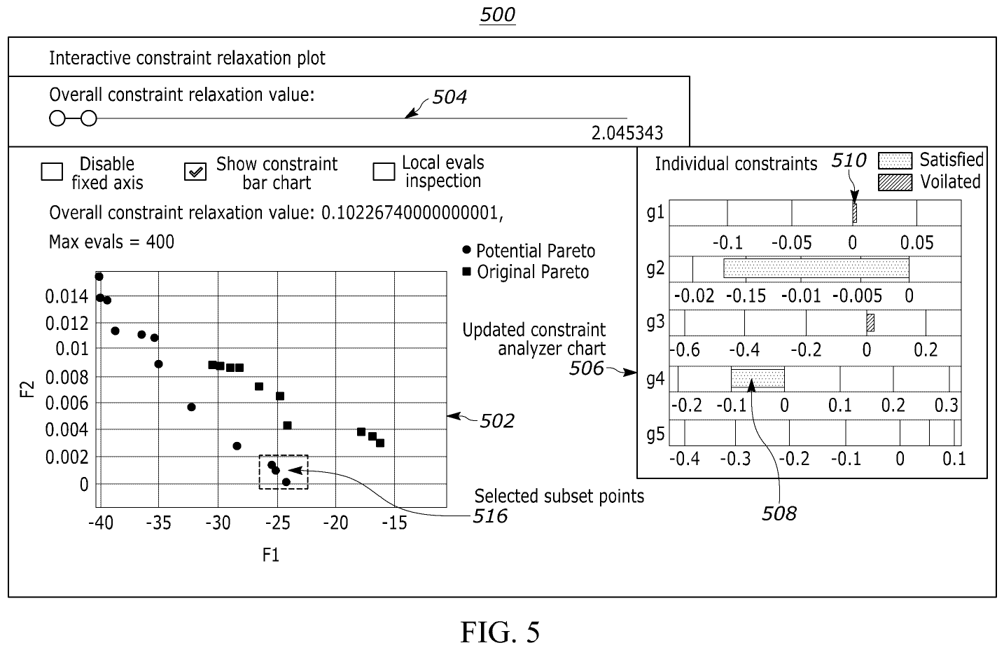

As described herein, the system can receive user interactions that fine-tune these “relaxations” indicated by the “violated” bands, which will dynamically update the potential Pareto set on the objective plot 402. In an example case, a design engineer may be interested in doing a local analysis of some subset of the potential Pareto points. This can be achieved by the user selecting the subset of points on the objective plot 402, and in response the system will dynamically update the constraint analyzer chart 406 to display statistical information about constraints, as illustrated in FIG. 5, which significantly enhances the decision-making capabilities of the design engineer or other user. In various embodiments, these user interactions can be accomplished by receiving a user adjustment to individual constraint relaxation values, such as using individual constraint sliders or otherwise, including by interacting with the individual constraints presented on the constraint analyzer chart 406, which can act as sliders or other inputs for the individual constraint relaxation values.

FIG. 5 illustrates an example of an updated user interface 500 (generally corresponding to user interface 400) for a system in accordance with disclosed embodiments, to analyze subset of pareto/potential pareto points. In this example, user interface 500 includes an objective plot 502 of the potential Pareto points and original Pareto points for objectives F1 and F2, but specifically highlights the selected subset 516 of the potential Pareto points.

An objective plot in accordance with various embodiments, such as objective plot 502, can be degenerated to a single objective plot or can be expanded to any number of multiple objectives. The objective plot can be presented in a variety of forms, including but not limited to a scatter plot, a line plot, a parallel plot, etc.

User interface 500 also includes an overall constraint relaxation “slider” 504 feature that allows the user to easily enter (and the system to receive) a dynamic adjustment of an overall constraint relaxation value, from zero to a maximum. Updated constraint analyzer chart 506 displays constraint ranges for each individual constraint, and the length of green/satisfied bands (e.g., at 508) and red/violated bands (e.g., at 510) indicate worst constraint value across the selected subset of potential Pareto Points (516). The system dynamically “connects” objective plot 502, slider 504, and constraint analyzer chart 506.

By comparing interface 400 of FIG. 4 and interface 500 of FIG. 5, it is evident that constraint analyzer chart 506 has been updated. Unlike in FIG. 4, where constraints g1, g3, and g5 were all violated, for the selected subset 516 of points in FIG. 5, only constraints g1 and g3 are violated and require constraint relaxation. For constraint g5, the value of violation is 0, meaning these points are lying at the constraint boundary defined by constraint g5.

Furthermore, the degree of constraint relaxation required for constraints g1 and g3 for the selected set of points is much less than that shown in FIG. 4 for the entire potential Pareto set. This can serve as a useful information for the design engineer to negotiate the constraint relaxation for constraints g1 and g3 to eventually select one of the points from the subset 516.

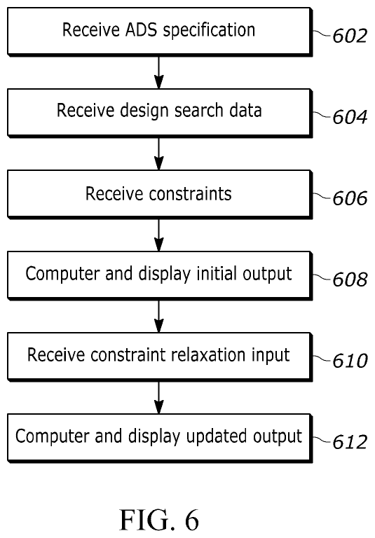

FIG. 6 depicts a flowchart of a process 600 in accordance with disclosed embodiments that may be performed, for example, by one or more computer systems as disclosed herein (referred to generically below as the “system”).

At 602, the system receives an automated design search (ADS) specification. The ADS specification can include any number of parameters or other information that define the ADS process, including a plurality of design variables, objective functions, constraints, performance metrics and evaluation criteria, algorithm parameters, and/or environmental and operational conditions. “Receiving,” as used herein, can include loading from storage, receiving from another device or process, receiving via and interaction with a user, and otherwise. This process can include loading and initializing an ADS software application, such as (but not limited to) the HEEDS design space exploration and optimization software by Siemens.

At 604, the system receives design search data. This can be received, for example, from a database of search datapoints generated by an ADS software application during a design space exploration task. The database can include information about each design which was encountered during the search, and can include a general archive of designs. This information can include values of all design parameters/variables, all design responses such as design objectives and design constraints, constraint violation values, etc. In one non-limiting example, the design search data can be stored in a data file such as that used by the HEEDS design space exploration and optimization software by Siemens.

At 606, the system receives a plurality of constraints, each constraint having an associated constraint threshold. Note that these constraints can be received as part of the ADS specification.

At 608, the system computes and displays an initial output of potential ADS solutions according to the ADS specification, the design search data, and the constraints. The potential ADS solutions can be an optimal set of solutions. The output can include, for example, any of the features disclosed herein, including an objective plot, a performance plot, and/or a constraint analyzer chart. The initial output can include, for example, Pareto solutions, Pareto points, and infeasible points. The initial output can indicate whether a given constraint is satisfied across an entire point set or is violated, for example using designated colors in a constraint analyzer chart. The initial output can include a performance plot that displays values of performance metric.

At 610, the system receives a constraint relaxation input from a user. This input can be received, for example, via the user's interaction with a slider graphical user interface (GUI) element on the initial output. The constraint relaxation input, in some embodiments, can range from zero to a predetermined maximum. In other embodiments, the constraint relaxation input can range from a predetermined minimum value, such as −1, to a predetermined maximum value, such as +1. The constraint relaxation input can be used to modify the constraint thresholds of the constraints. In various embodiments, the constraint relaxation input can be an interaction with an overall constraint relaxation input, such as illustrated at 404. The constraint relaxation input can be received in a number of ways in various embodiments; for example, it can be received via a slider, by a manual user entry, by another interactive mechanism like a “roller wheel” to increase and decrease the constraint relaxation value, or otherwise.

Alternatively or additionally, the constraint relaxation input can be an interaction with a dedicated slider or other mode of interactive mechanism for each constraint in a constraint analyzer chart, such as illustrated at 410, to individually modulate constraint relaxation values.

At 612, in response to receiving the constraint relaxation input, the system computes and displays an updated output of potential ADS solutions, according to the ADS specification, the constraints, and the constraint relaxation input. In various embodiments, the updated output can include original Pareto points/solutions, as illustrated in the initial output, potential Pareto points/solutions, and other information. The potential Pareto points/solutions can reflect Pareto solutions according to the modified constraint relaxation values relative to the original definition of the ADS specification. In various embodiments, the updated output of potential ADS solutions is a potential optimal set of solutions. In various embodiments, the updated output can include an updated constraint analyzer chart indicating whether given constraints are satisfied or violated, for example, whether given constraints are satisfied or violated for the set of potential optimal solutions when the constraint relaxation input is used to modify the constraint threshold for that constraint, when individual constraints are relaxed, or when the overall constraint relaxation input is used to implicitly modify the constraint thresholds of individual constraints. In various embodiments, the updated output of potential ADS solutions includes a “best set of points” of potential solutions, which can illustrate either single- or multi-objective solutions.

When the constraint relaxation input is a change to an individual constraint in the constraint analyzer chart, for example, the system can dynamically update potential Pareto points/solutions in objective plot 402 and the slider position of the overall constraint relaxation slider 404. In such a case, when the system receives a constraint relaxation input that includes a change in individual slider positions, the system can automatically and dynamically update the objective plot (whether single or multiple objective), the overall constraint relaxation slider, and any other changed aspects for the updated output.

The system can then repeat 610 and 612 as the system continues to receive the constraint relaxation input, so that the system dynamically and repeatedly updates the updated output when the constraint relaxation input continues to be received, such as when a slider is “slid” from one position to another.

Disclosed embodiments provide a number of distinct technical advantages over other systems. In particular, the ability to interact with a user to receive constraint-relaxation adjustments, such as using the overall constraint relaxation slider, enables the system to easily and dynamically filter potential Pareto solutions and provide an effective and intuitive output to the user. This process also aids in pre-setting relaxation parameters for individual constraints for fine tuning or other specific adjustments. Further, various embodiments can lock the constraint relaxation setting of individual constraints to a desired value, which can be either 0 or any other value of interest to user, or some user desired interval. With that, any movement in the overall constraint relaxation slider will not allow relaxation value of an individual constraint to go beyond the user specified value or interval.

Disclosed embodiments also enable automated dynamic non-dominated sorting, which can be conducted by the system on the modified and updated optimization problem based on changes in constraint relaxation. Dynamic non-dominated sorting enables the system to provide users the filtered potential pareto points, and can be automatically performed on the updated set of feasible points the moment a user changes the constraint relaxation value, so that the system can immediately compute and display the updated potential pareto points.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all computer systems suitable for use with the present disclosure is not being depicted or described herein. Instead, only so much of a computer system as is unique to the present disclosure or necessary for an understanding of the present disclosure is depicted and described. The remainder of the construction and operation of computer system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle. The use of terms such as (but not limited to) “mechanism,” “module,” “device,” “unit,” “component,” “element,” “member,” “apparatus,” “machine,” “system,” “processor,” or “controller,” within a claim is understood and intended to refer to structures known to those skilled in the relevant art, as further modified or enhanced by the features of the claims themselves, and is not intended to invoke 35 U.S.C. § 112(f).

What is claimed is:

1. A method (600) for automated design search, the method performed by a computer system (100) and comprising:
receiving (602) an automated design search (ADS) specification (154);
receiving (604) design search data (166);
receiving (606) a plurality of constraints (156), each constraint (156) having an associated constraint threshold (156);
computing and displaying (608) an initial output (400) of potential ADS solutions (158) according to the ADS specification (154), the design search data (166), and the constraints (156);
receiving (610) a constraint relaxation input (162) from a user; and
in response to receiving (610) the constraint relaxation input (162), computing and displaying (612) an updated output (500) of potential ADS solutions (158), according to the ADS specification (154), the constraints (156), the design search data (166), and the constraint relaxation input (162).

2. The method of claim 1, further comprising dynamically and repeatedly updating (612) the updated output (500) when the constraint relaxation input (162) continues to be received (610).

3. The method of claim 1, wherein the ADS specification (154) includes one or more of design variables, objective functions, constraints, performance metrics and evaluation criteria, algorithm parameters, or environmental and operational conditions.

4. The method of claim 1, wherein the initial output (400) includes an objective plot (402), a performance plot, or a constraint analyzer chart (406).

5. The method of claim 1, wherein the initial output (400) includes an objective plot (402) that displays Pareto solutions and/or infeasible points or a performance plot that displays values of performance metric.

6. The method of claim 1, wherein the initial output (400) includes a constraint analyzer chart (406) that indicates whether each constraint (156) is satisfied across an entire point set or is violated.

7. The method of claim 1, wherein the constraint relaxation input (162) can be used to modify the constraint thresholds (156) of the constraints (156).

8. The method of claim 1, wherein the constraint relaxation input (162) is received via a user interaction with a slider graphical user interface element (404) on the initial output (400).

9. The method of claim 1, wherein the constraint relaxation input (162) ranges from zero to a predetermined maximum.

10. The method of claim 1, wherein the constraint relaxation input (162) ranges from a predetermined minimum value to a predetermined maximum value.

11. The method of claim 1, wherein the updated output (500) includes original Pareto points that are illustrated in the initial output (400) and includes potential Pareto points.

12. The method of claim 1, wherein the updated output (500) includes an updated constraint analyzer chart (506) that indicates whether the plurality of constraints (156) are satisfied when the constraint relaxation input (162) is used to modify the constraint threshold (156) for the associated constraint (156).

13. The method of claim 1, wherein the constraint relaxation threshold can be adjusted for each constraint (156) individually using dedicated sliders corresponding to each constraint (156).

14. The method of claim 1, wherein computing and displaying (612) the updated output (500) of potential ADS solutions (158) includes dynamically updating an objective plot (502) and an overall constraint relaxation slider (404) based on the constraint relaxation input (162).
